(19) United States
(12) Patent Application Publication
(10) Pub. No.: US 2022/0402745 A1
(43) Pub. Date: Dec. 22, 2022

(54) KEG CLOSURE WITH INTEGRATED VENTING SYSTEM HAVING A RUPTURE DISK

(71) Applicant: PETAINER LARGE CONTAINER IP LIMITED, London (GB)

(72) Inventors: Duncan Shearman, London (GB); Femando C. Ricaldoni, London (GB); Paul Prior, London (GB)

(21) Appl. No.: 17/773,235

(22) PCT Filed: Oct. 30, 2020
(86) PCT No.: PCT/GB2020/052755

§ 371 Date: Apr. 29, 2022

(30) Foreign Application Priority Data
Nov. 1, 2019 (GB) 1915913.6

(51) Int. Cl. B67D 1/12; B67D 1/08

(52) U.S. Cl. CPC B67D 1/125; B67D 1/0831

(57) ABSTRACT

A closure (12) for a beverage keg (10) for the pressurised delivery of a beverage, the closure comprising: a valve housing (38) comprising a valve housing wall (32) and an inlet and configured to house a valve (26) for controlling a flow of pressurised gas through the inlet into a headspace of the beverage keg (10); a venting aperture (27) in the valve housing wall, separate from the inlet and arranged to vent the headspace of the beverage keg; and a barrier (29), integrally formed with the valve housing wall and arranged to seal the venting aperture (27) such that the closure (12) is able to retain the pressurised gas within the keg when the closure is arranged in an unvented configuration, the barrier (29) being configured to rupture due to internal pressure from within the keg in order to switch the closure into a vented configuration in which the venting aperture (27) is no longer sealed by the barrier, wherein the barrier is formed as a geometrical shape having a barrier diameter or a barrier width in the range of 7 mm to 12 mm and wherein, in at least a part of the barrier, a barrier thickness is lower than a thickness of the valve housing in the immediate surroundings of the venting aperture and in the range of 0.02 mm to 0.5 mm.

### TECHNICAL FIELD

Aspects of the invention relate to closure for a beverage keg that is configured for storing, transporting and dispensing beverage. Aspects of the invention further relate to a beverage keg supplied with or fitted with such a closure.

### BACKGROUND

Kegs are widely used in the distribution and dispensing of beverages such as beer. Kegs are typically provided with a closure that closes and seals a neck of the keg. The closure may define a pair of flow paths that enable beverage to be introduced into the keg during a filling operation, which is generally performed with the keg inverted. The flow paths may further enable beverage to be dispensed from the keg, for example with pressurised gas being introduced into the keg via a first one of the flow paths in order to force beverage out of the keg via the second flow path.

Plastic kegs have been introduced to the market, including disposable kegs that are stretch blow moulded from a preform PET or another polymer material. It is generally desirable to ensure that the keg is depressurised after use, for example after the contents of the keg have been dispensed, so that the keg can be crushed prior to their disposal. For safety purposes, it is also desirable to limit the internal pressure experienced within a keg. To limit the internal pressure, some closures include an automatic venting system. However, known venting systems are generally complicated and expensive, especially when applied to plastic closures that may in some cases be disposable items intended for disposal together with a keg after use, and may not provide reliable venting at a consistent internal pressure.

An example of a keg closure with an integrated venting system is described in the international patent application WO 2018/142147 A1. Although the keg closure with integrated barrier described therein has proven to be functional, it still leaves something to be desired in terms of performance, ease of manufacturing, reproducibility and reliability.

It is generally desirable to minimise the cost and complexity of keg closures, to increase the ease of assembly, and to provide a rugged design. However, known closures often include a significant number of parts forming the main structure of the closure, and can be difficult and time-consuming to assemble.

It is an aim of the present invention to address disadvantages associated with the prior art.

### SUMMARY OF THE INVENTION

Against this background, in a first aspect the embodiments of the invention provide a closure for a beverage keg for the pressurised delivery of a beverage, the closure comprising a valve housing, a venting aperture and a barrier. The valve housing comprises a valve housing wall and an inlet and is configured to house a valve for controlling a flow of pressurised gas through the inlet into a headspace of the beverage keg. The venting aperture in the valve housing wall is separate from the inlet and arranged to vent the headspace of the beverage keg. The barrier is integrally formed with the valve housing wall and arranged to seal the venting aperture such that the closure is able to retain the pressurised gas within the keg when the closure is arranged in an unvented configuration. The barrier is configured to rupture due to internal pressure from within the keg in order to switch the closure into a vented configuration in which the venting aperture is no longer sealed by the barrier. The barrier is formed as a geometrical shape having a barrier diameter or a barrier width in the range of 7 mm to 12 mm. In at least a part of the barrier, a barrier thickness is lower than a thickness of the valve housing in the immediate surroundings of the venting aperture and in the range of 0.02 mm to 0.5 mm.

Through extensive research, taking into account many design parameters of the keg closure and its venting system and considering many factors like performance, reliability, safety, cost and ease of manufacturing, the inventors have now come up with a fully satisfactory venting aperture barrier that can be integrated in an easy to manufacture keg closure. In this process, it turned out that especially the combination of the now claimed specific barrier size and thickness play an important role in achieving the objectives of the invention.

The inventors have found that the best results are obtained when, in at least a part of the barrier, the barrier thickness is in the range of 0.02 mm to 0.5 mm. This turned out to be particularly the case when the barrier width or the barrier diameter is in the range of 7 mm to 12 mm. A preferred integrated barrier was formed by a circular barrier with a 10 mm diameter and a thickness between 0.04 mm to 0.4 mm. The barrier may comprise a surface having complex shapes including domed and/or curved elements and a thickness varying between 0.04 mm to 0.4 mm. At least one of the domed and/or curved surface elements may be configured to extend outwardly or inwardly from the barrier surface. It is noted that for non-circular shapes, a similar diameter will bring good results. For such non-circular shapes, we herewith define diameter as the shortest edge to edge line crossing the centre of the barrier.

In an embodiment of the closure according to the invention, the barrier thickness is substantially uniform. A uniform barrier thickness brings the advantage that it is relatively easy to manufacture and, partly because of that, provides a very reproducible and predictable barrier that can be precisely tuned to burst at a specific burst pressure range of, for example, between 5.0 and 6.5 bar. Advantageously, there is a relation between the barrier portions having a uniform thickness and the barrier portions having a non-uniform thickness to ensure that the closure will burst in the desired pressure range.

In another embodiment, the barrier thickness is not uniform. While the manufacturing of such a barrier may be a little bit more complex and costly, the varying barrier thickness provides a very predictable bursting behaviour. The thinner parts of the barrier will generally burst before the thicker parts do so and will subsequently determine the directions in which the barrier is ruptured. The thicker regions of the barrier may be configured to maintain the closure in place even after bursting.

When the barrier has a non-uniform thickness, it is desirable that at least a region at a circumference of the geometrical shape has a barrier thickness in the range of 0.02 mm to 0.5 mm, or preferably in the range of 0.04 mm to 0.4 mm. Other parts of the barrier may then have a higher or lower barrier thickness. When the remaining part, or most of the remaining part, of the barrier has a higher barrier thickness, the barrier can be expected to initially burst at the at least one region at the circumference of the geometrical shape, thereby ensuring that the full venting aperture will be opened. The remaining regions of the barrier may be configured to maintain the closure in place even after the initial bursting of the geometrically shaped region.

The non-uniformity of the barrier thickness may be the result of an indented region with a reduced barrier thickness relative to its immediate surroundings. Such, so called, burst marks can improve safety by further ensuring that the barrier will burst at the intended burst pressure and can also increase the predictability of the bursting behaviour.

For example, the indented region comprises a pair of intersecting grooves. Such intersecting grooves may, for example, form a cross or star. A length of at least one of the intersecting grooves may be in the range of 2 mm to 12 mm, or preferably in the range of 6 to 10 mm. Different grooves may have different lengths. The reduced barrier thickness at the indented region may be in the range of 0.02 mm to 0.5 mm, alternatively in the range of 0.05 mm to 0.4 mm. The indented region may be provided at an inward and/or at an outward facing surface of the barrier.

Because the barrier has a lower thickness than the surrounding valve housing, the barrier will never fill the full venting aperture. The barrier may therefore be arranged at an inward or at an outward facing opening of the venting aperture. Alternatively, the barrier is arranged somewhere in between the two openings of the venting aperture.

The closure may, for example, be formed of at least one of TPU, HDPE, PP and POM.

According to a second aspect of the invention, there is provided a closure for a beverage keg for the pressurised delivery of a beverage is provided. The closure comprises a valve housing with an inlet and configured to house a valve for controlling a flow of pressurised gas through the inlet into a headspace of the beverage keg. The valve housing comprises a head portion, a body portion, a venting aperture and a barrier. The head portion is configured for receiving at least an upper portion of the neck of the beverage keg and for attachment to a beverage filling and/or dispense system. The body portion is configured to be at least partially inserted into a neck of the beverage keg. The venting aperture is provided in a wall of the head portion, separate from the inlet and arranged to vent the headspace of the beverage keg The barrier is integrally formed with the wall of the head portion and arranged to seal the venting aperture such that the closure is able to retain the pressurised gas within the keg when the closure is arranged in an unvented configuration. The barrier is configured to rupture due to internal pressure from within the keg in order to switch the closure into a vented configuration in which the venting aperture is no longer sealed by the barrier. The head portion, the body portion and the barrier are integrally formed together such that the valve housing defines a single component of the closure.

This new arrangement integrating all of the head portion, body portion and the venting aperture in a single component provides a considerable improvement over, for example, the keg closure disclosed in WO 2018/142147 A1. The new closure keg has fewer components and is therefore easier to assemble and more reliable in use. By having the venting aperture in the head portion, it is ensured that it will always be situated above the neck of the keg and will thus be able to release the pressurised gas into the air when the barrier bursts.

As before, the barrier is preferably formed as a geometrical shape having a barrier diameter or a barrier width in the range of 7 mm to 12 mm and wherein, in at least a part of the barrier, a barrier thickness is lower than a thickness of the valve housing in the immediate surroundings of the venting aperture and in the range of 0.02 mm to 0.5 mm. Also other features and aspects of the keg closure described above can be used to further enhance this keg closure.

All keg closures disclosed herein can, for example, be obtained by an injection moulding process wherein the barrier is obtained by temporarily compressing a barrier portion of the valve housing during the injection moulding.

According to another aspect of the invention, there is provided a method of forming a closure for a beverage keg, the closure comprising a valve housing according to any one of the preceding paragraphs. The method comprises: injection moulding a valve housing of the closure; compressing a barrier portion of the valve housing during the injection moulding; and forming an indented region of the barrier portion, the indented region having a reduced barrier thickness relative to its immediate surroundings.

Forming the indented region may comprise scoring a region of the barrier portion with a laser to obtain a pair of intersecting grooves in the barrier portion. Scoring the region of the barrier portion may comprise forming at least one of the intersecting grooves with a length in the range of 2 mm to 12 mm, preferably in the range of 4 to 8 mm.

In embodiments, the keg closure is obtained by an injection moulding process wherein the barrier is obtained by temporarily compressing a barrier portion of the valve housing during the injection moulding; a region of the barrier portion being scored by a laser to obtain an intersecting groove in the barrier portion. The scored region may comprise varying shapes and thicknesses. The inventors have found that the laser scoring process provides a very precise means of obtaining intersecting grooves. The inventors have discovered that by using the laser scoring process they are able to control the dimensions of the intersecting grooves with more accuracy than compared to using the temporary compressing process alone.

According to another aspect of the invention, a beverage keg is provided, supplied with or fitted with a closure as described above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

The invention will now be described by way of example with reference to the accompanying drawings, in which:

FIG. 1 is a perspective view of a keg assembly;

FIG. 2 is an exploded view of the keg assembly shown in FIG. 1;

FIG. 3 is a perspective view of a keg closure according to the invention;

FIG. 4 is an exploded view of the keg closure shown in FIG. 3;

FIG. 5 is a cross section through the valve housing of FIG. 4;

FIG. 6a is a close-up of part of the cross-section of FIG. 5;

FIG. 6b is a front view of the barrier shown in FIG. 6a

FIGS. 7a, 7b, 8a and 8b are cross sections and front views of two alternative embodiments of barriers for a keg closure according to the invention.

### DETAILED DESCRIPTION

The following detailed description refers to the accompanying drawings that show, by way of illustration, specific details and embodiments in which the invention may be practiced. These embodiments are described in sufficient detail to enable those of ordinary skill in the art to practice the invention. Other embodiments may be utilised, and structural changes may be made without departing from the scope of the invention as defined in the appended claims.

The present invention relates to a closure for a beverage keg, the closure including a venting mechanism which is configured to enable rapid depressurisation of the keg in the event that the internal pressure of the keg exceeds a predetermined level.

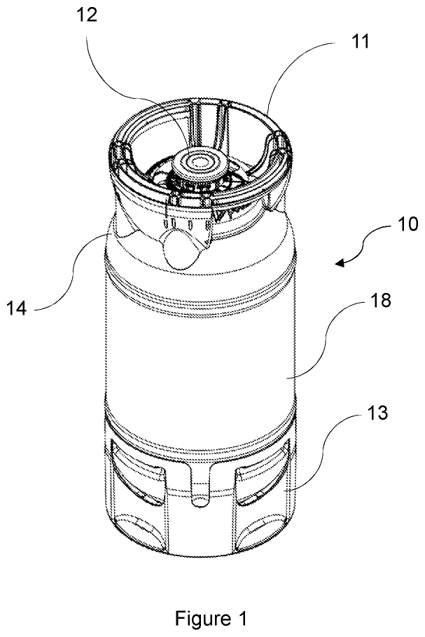

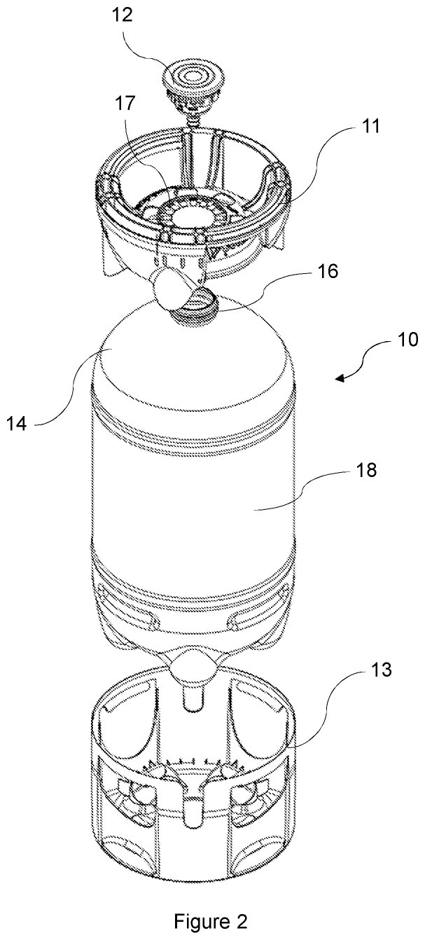

FIG. 1 illustrates a keg assembly comprising a plastic keg 10, a top chime 11, a bottom chime 13 and a closure 12 according to an embodiment of the present invention. An exploded view of the keg assembly is illustrated in FIG. 2. It is noted that this keg assembly is just provided as an example. The keg closure 12 may, for example, also be used in a free-standing keg that is not combined with a top chime 11 or bottom chime 13 as shown in FIG. 1.

The keg 10 comprises a substantially hemispherical base portion including a plurality of blister like feet arranged in a petaloid formation on which the keg 10 may stand in use. The keg 10 further comprises a cylindrical body portion 18 that is integrally formed with and extends upwardly from the top of the base portion, and a substantially hemispherical shoulder portion 14 that is integrally formed with the body portion 18 at the top edge thereof.

The keg 10 is stretch blow moulded from a preform of plastic, such as a PET preform, and is configured to be used in the distribution and pressurised dispensing of a beverage such as draught beer (although in other embodiments the keg 10 may equally be configured for use with other carbonated or non-carbonated beverages). The keg 10 is designed to be self-standing on the feet of its base portion in use (for example during pressurised dispensing using conventional draught beer dispensing apparatus), although in the present embodiment the keg 10 is intended to be used in combination with a bottom chime 13. The keg 10 is configured to be able to independently withstand the internal pressures associated with the pressurised dispensing of draught beer (for example at a pressure of 1 to 4 bar). The keg 10 may include a barrier layer in order to increase the shelf life of beer contained therein.

The top chime 11 comprises a mounting portion, which is configured for mounting the top chime 11 to the keg 10, in combination with a collar (not shown), which is configured to secure the mounting portion 17 to the neck 16 of the keg 10. The mounting portion 17 is generally annular in shape and defines a central aperture that is configured to receive the neck portion 16 of the keg 10.

The top of the shoulder portion 14 of the keg 10 is provided with a neck portion 16 (hereinafter referred to as the neck 16) that defines an opening of the keg 10. The neck 16 is configured to receive and retain the closure 12, which may be secured to the neck 16 by a snap-fit engagement. The closure 12 is configured to snap over an annular ring provided around the neck 16 in order to enable the closure 12 to be snap-fitted, and securely retained, on the neck 16 of the keg 10, as described in more detail below.

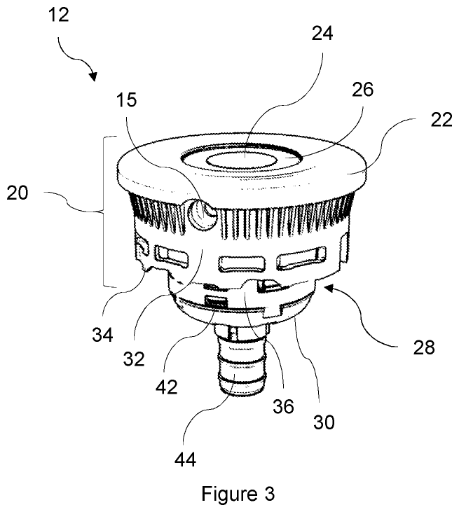

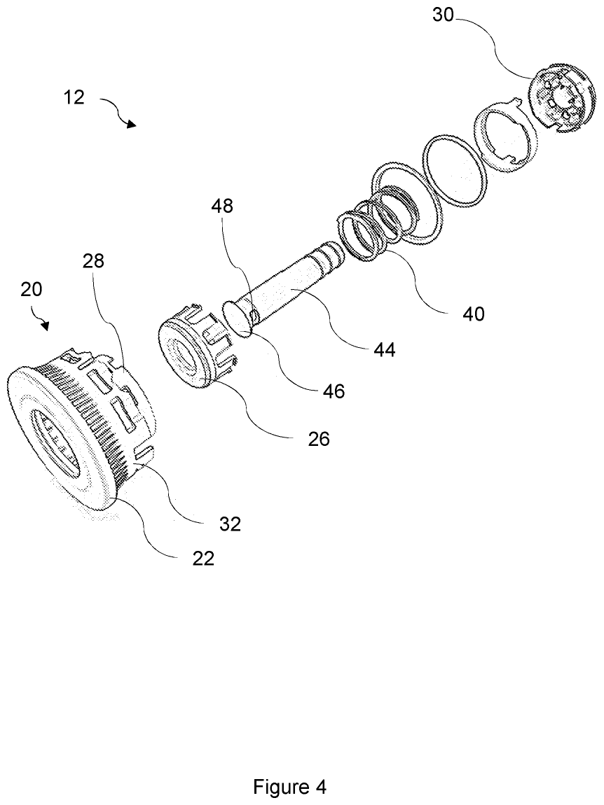

The closure 12, which is shown in more detail in FIG. 3 and in exploded view in FIG. 4, defines a pair of concentric flow paths into and out of the keg 10 that may be selectively opened and closed by a valve arrangement. The closure 12 includes a spear connector, i.e. an inner duct 44, for connection to a dip tube or spear that extends to a location near to the bottom of the keg 10 when the closure 12 is mounted to the keg 10.

It will be appreciated that all references to directions made in relation to the closure 12 and components of the closure 12 throughout this specification, such as “upwardly”, “downwardly”, “top”, “bottom” and “underside”, are made with respect to a closure in an upright orientation as illustrated in FIGS. 1 to 3, this being the orientation in which the closure 12 is arranged when connected to a keg 10 that is standing in an upright orientation on its base. It will further be appreciated that the orientations of each part of the closure 12 may vary in use.

The closure 12 comprises an attachment part 20—or outer head part 20—which includes a snap ring for attaching the closure 12 to the neck 16 of the keg 10. The attachment part 20 comprises an annular head portion 22 that is arranged at the top of the neck 16 of the keg 10 when the closure 12 has been fitted to the keg 10. The head portion 22 has a substantially planar top surface and includes a flange portion that overhangs the neck 16 of the keg 10, and is configured to cooperate with filling heads and dispense heads.

This particular closure 12 is a so-called Type-A closure, and the head portion 22 is configured to cooperate with standard Type-A filling heads and dispense heads used in the distribution and pressurised dispensing of draught beer in a conventional manner. It is noted that the invention is, however, not limited to Type-A closures and can also be applied to other types of keg closures for the pressurised dispensing of beverages.

The head portion 22 comprises a central aperture 24 that is configured to be opened and closed by a movable valve element 26 in order to selectively open and close concentric inner and outer flow paths through the closure 12, as described in more detail below. The head portion 22 further comprises a flange which extends radially from the central aperture 24. The flange is configured to be engaged by an attachment means of the filling and dispense heads in order to retain the heads in place during use.

The closure 12 further comprises a housing component 28, which is integrated with the attachment part 20. The attachment part 20 comprises an outer attachment portion 32—or annular wall 32—that extends downwardly from the flange of the head portion 22. The annular wall 32 is configured to receive at least an upper portion of the neck 16 of the keg 10 therein when the closure 12 has been fitted to the keg 10. The annular wall 32 is provided with a plurality of clip formations 34 towards its lower end. The clip formations 34 extend radially inwardly from the annular wall 32 and are configured to snap over an annular ring provided around the neck 16 of the keg 10 in order to enable the closure 12 to be snap-fitted onto and securely retained on the neck 16 of the keg 10.

The integrated housing component 28 also comprises an annular wall 36 which, together with the head portion 22, defines a valve housing 38 of the closure 12, within which the valve element 26 is housed. The valve housing 38 also houses a spring 40 (shown in FIG. 4) which is configured to bias the valve element 26 towards a closed position.

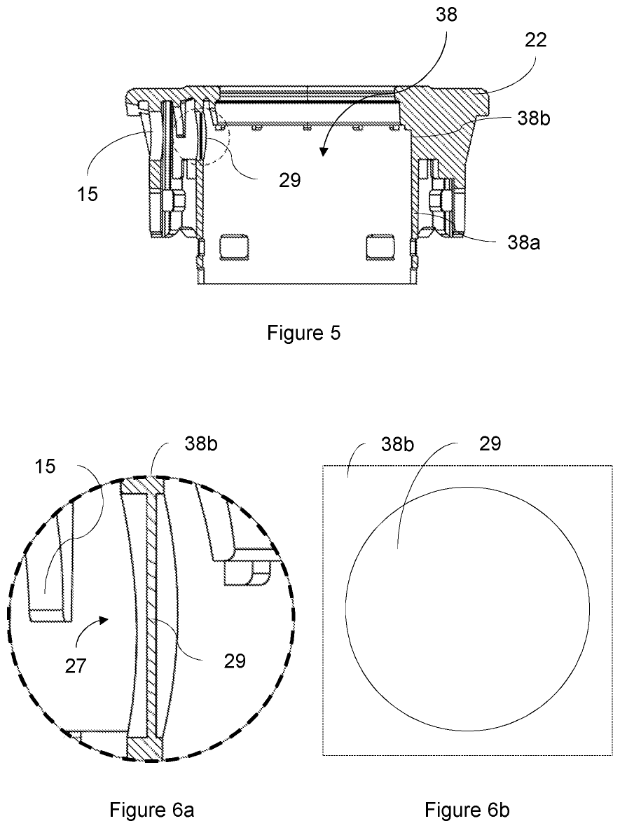

With particular reference to FIG. 5, the main body 38a of the valve housing 38 is defined by the annular wall 36 of the integrated housing component 28, and the top part 38b of the valve housing 38 is defined by the head portion 22, i.e. the portion that, in use. remains above the top of the neck.

The closure 12 further comprises a base portion 30 (see FIGS. 3 and 4), which is arranged concentrically with the housing component 28. The base portion 30 is configured to be separable from the housing component 28 in order to allow the valve components to be assembled within the valve housing 38. The base portion 30 is configured to engage with an opening towards the lower part of the housing component 28 such that it defines a cap for the closure 12. The base portion 30 is detachably mounted to the lower part of the housing component 28 by a plurality of clip formations 42 (FIG. 3) that are connected to the base portion 30 adjacent to its top edge. The clip formations 42 are received within a corresponding plurality of apertures provided in the annular wall 36 of the housing component 28 when the base portion 30 has been push-fitted together with the housing component 28.

The closure 12 further comprises an inner duct part 44 or spear connector, in the form of an elongate tube, which is arranged within the valve housing 38 when the closure 12 is arranged in an assembled configuration. The duct part 44 extends through a concentrically aligned aperture of the base portion 30, which is arranged to hold the duct part 44 in position when the closure 12 is arranged in the assembled configuration.

The inner duct 44 is arranged concentrically within and extends through the valve housing 38. In this way, the inner duct 44 divides the valve housing 38 into an annular outer space (between the main body 38a and the inner duct 44) defining an outer flow path through the closure 12, and an inner space (inside the inner duct 44) defining an inner flow path through the closure 12.

The inner duct 44 extends to towards the top of the valve housing 38, and is provided with an end cap 46 at its upper end. The inner duct 44 is further provided with an aperture 48 arranged below its end cap 46. An aperture 48 is arranged to allow fluid communication between the interior of the inner duct 44 and the region immediately surrounding the upper end of the inner duct 44.

The valve element 26 is configured for sliding movement along the inner duct 44 within the valve housing. The valve element 26 has an upper closed position (illustrated in FIG. 1) in which the head portion of the valve element 26 engages and forms a seal with the head portion 22 of the attachment part 20 and the end cap 46 of the inner duct 44, thereby closing the outer and inner flow paths through the closure 12. The valve element 26 is movable into an open position by depressing the valve element 26 with respect to the valve housing 38. When the valve element 26 has been moved into an open position, fluid communication between the outer flow path and the exterior of the closure 12 is permitted between the valve element 26 and the head portion 22 of the attachment part 20, and fluid communication between the inner flow path and the exterior of the closure 12 is permitted between the valve element 26 and the end cap 46 of the inner duct 44.

The inner duct 44 extends downwardly to provide a tail portion that may be press fitted into an elongate tube or spear (not illustrated). The tube preferably extends to a position at or close to the bottom of the keg 10 in order to provide fluid communication between the bottom of the keg 10 and the interior of the inner duct 44, thereby allowing beverage contained within the keg 10 to be drawn from the bottom of the keg 10 up into the interior of the inner duct 44 and through the closure 12 via the inner flow path.

The attachment part 20, integrated housing component 28 and valve element 26 are each preferably injection moulded plastics components. Suitable plastics that may be used for these parts are, for example, TPU, HDPE, PP and POM. The above-described closure 12 may be assembled by first inserting the spring 40 and valve element 26 into the annular space defined between the annular wall 36 and the inner duct 44 of the integrated housing component 28. The end cap 46 may then be press fitted into the inner duct 44 and the integrated housing component 28 may be press fitted together with the attachment part 20 in order to complete the closure 12. The elongate tube may optionally be supplied together with the closure 12, and may be fitted to the closure before the closure 12 is fitted to the neck 16 of a keg 10.

The above-described closure construction results in a closure 12 that is simple, rugged and reliable. The closure 12 is also easy to assemble with a low parts count.

In accordance with the present invention, the closure 12 is provided with a venting system for automatically limiting internal pressure within a keg 10 to which the closure 12 is fitted. The venting system comprises a venting aperture 27 formed through a portion of the valve housing 38. In the present embodiment the venting aperture 27 takes the form of a circular hole with a diameter of approximately 10 mm that extends through the top part 38b of the valve housing 38, as illustrated in FIG. 5. The venting aperture 27 is thus provided in the head portion 22 and at a location close to the top edge of the annular wall 36 of the housing component 28, and therefore is located outside the neck 16 of the keg 10 when the closure 12 has been fitted to the keg 10.

The venting aperture 27 is provided with a barrier 29 that is integrally formed with the valve housing wall around the venting aperture 27. The barrier 29 closes and seals the venting aperture 27 when the closure 12 is in an unvented configuration (for example as supplied to customers for use).

The venting aperture 27 and the barrier 29 are preferably positioned such that automatic venting of the keg 10 is permitted while the closure 12 is coupled to a filling head or a dispense head (for example during a filing or dispensing operation). The barrier 29 is also configured to permit automatic venting after the closure 12 has been separated from a filling head or a dispense head (for example after the completion of a filling operation, or after the contents of the keg 10 has been dispensed).

The barrier 29 is not resealable, and so the depressurisation caused by the rupturing of the barrier 29 is permanent, and it is not subsequently possible for the keg 10 to be re-pressurised and used with the closure 12 still attached to the keg 10. In the embodiments below, which will be described with reference to FIGS. 6a to 8b, the barrier 29 has a circular shape with a diameter in the range of 7 mm to 12 mm and at least part of the barrier 29 has a thickness that is in the range of 0.02 mm to 0.5 mm.

Through extensive research, taking into account many design parameters of the keg closure 12 and its venting system and considering many factors, such as performance, reliability, safety, cost and ease of manufacturing, the inventors have discovered that a fully satisfactory venting aperture barrier 29 that can be integrated in an easy to manufacture keg closure 12 needs such dimensions. In this process, it was determined that the combination of the correct barrier size and thickness plays an especially important role in achieving the objectives of the invention. It is considered, however, that similar results may be achieved with a non-circular, for example, oval, egg-shaped, or polygonal shape (triangular, rectangular, pentagonal, etc.). Accordingly, it will be appreciated by the skilled person that the optimal dimensions of the barrier may vary depending on the exact shape and material of the barrier 29.

The inventors have found that, for the circular barrier 29 shown in the drawings, the best results are obtained when at least a part of the barrier 29 has a barrier thickness in the range of 0.02 mm to 0.5 mm. This range of barrier thicknesses was found to be particularly effective in situations where the width or diameter is in the range of 9.5 mm to 10.5 mm. A preferred integrated barrier 29 is formed by a circular barrier 29 with a 10 mm diameter and a 0.2 mm thickness. For the situations where the barrier has a uniform thickness, the barrier thickness refers to the thickness across the barrier. Alternatively, in exemplary arrangements of the closure in which the barrier has a non-uniform thickness, the barrier thickness may vary significantly across the barrier. Hence, the barrier thickness referred to herein (e.g. 0.2 mm) refers to an average thickness (i.e. a mean thickness across the surface of the barrier).

FIG. 6a is a close-up of part of the cross-section of FIG. 5 and shows the aperture 27 in the top portion 38b of the valve housing 38 being closed off by a barrier 29. In this example, the barrier 29 has a substantially uniform thickness (in the range of 0.02 mm to 0.5 mm, preferably in the range of 0.04 mm to 0.4 mm, for example 0.12 mm). A uniform barrier thickness brings the advantage that it is relatively easy to manufacture and provides a very reproducible and predictable barrier 29 that can be precisely tuned to burst at a specific burst pressure of, for example, 6 bar.

Because the barrier 29 has a thickness which is less than the thickness of the surrounding valve housing 38, the barrier 29 will never occupy the full depth of the venting aperture 27. The barrier 29 may therefore be arranged at an inward or at an outward facing opening of the venting aperture 27. Alternatively, as in the exemplary embodiment shown in FIG. 6a, the barrier 29 is arranged somewhere in between the outward and inner openings of the venting aperture 27.

FIG. 6b is a front view of the barrier 29 shown in FIG. 6a. The barrier 29 has a uniform thickness and a flat surface. It has a circular shape with a diameter in the range of 7 mm to 12 mm, preferably in the range of 9.5 mm to 10.5 mm and, for example, 10.0 mm. According to an exemplary arrangement of the closure, the barrier may comprise a surface having complex shapes including domed and/or curved elements. At least one of the domed and/or curved surface elements may be configured to extend outwardly or inwardly from the barrier surface.

The annular wall 32 of the attachment part 20 of the closure 12 extends downwardly from the head portion 22 to a level below the venting aperture 27 and the barrier 29. The annular wall 32 of the attachment part 20 provides protection to the barrier 29 when the closure 12 has been fully assembled by preventing the barrier 29 being involuntarily damaged, for example, during handling or transport of the keg 10 or when attaching a dispense head of a beverage dispensing system. However, the annular wall 32 of the attachment part 20 may be provided with an inspection/access aperture 15 extending therethrough which is aligned with the venting aperture 27 provided in the annular wall 32. The inspection/access aperture 15 provided in the annular wall 32 of the attachment part 20 allows visual inspection of the barrier 29. The inspection/access aperture 15 also allows access to the barrier 29 to enable targeted manual depressurisation of the keg 10 to which the closure 12 is attached. For example, a pin or other tool may be manually inserted through the inspection/access aperture 15 and used to rupture the barrier 29 to move the barrier into an unsealed state and thereby depressurise the keg 10.

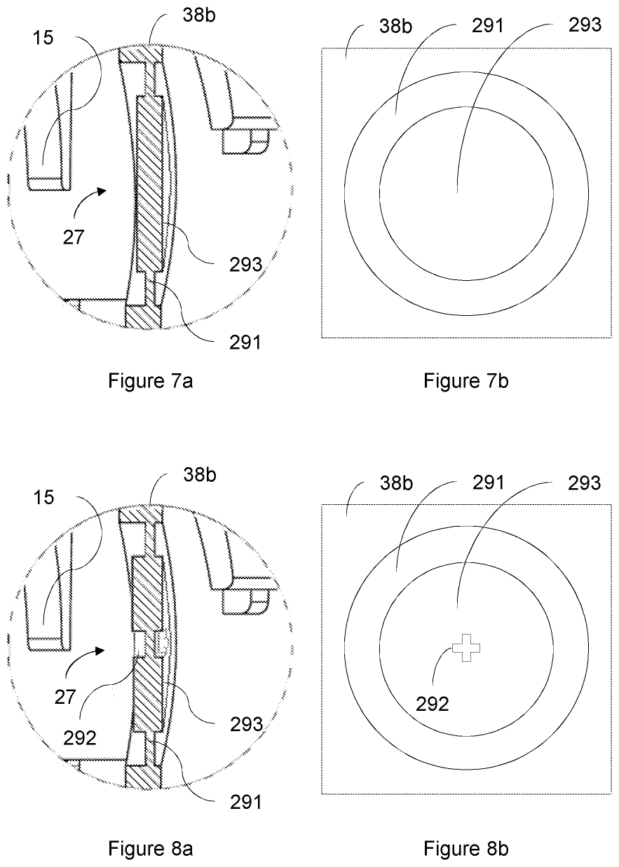

FIGS. 7a, 7b, 8a and 8b show cross sections and front views of two alternative embodiments of barriers 29 for a keg closure 12 according to the invention. In both alternative embodiments, the barrier thickness is not uniform. The varying thickness in of the barrier 29 may help to further increase the predictability of the bursting dynamics of the barrier 29. The thinner parts of the barrier 29 will generally burst before the thicker parts and will thereby determine the manner in which the barrier ruptures. For example, the non-uniform thickness of the barrier may provide regions of the barrier 29 where the stress, due to the internal pressure of the keg 10, may be concentrated. The regions of enhanced stress concentration lead to the eventual rupturing of the barrier 29 in particular directions, as determined by the tensional forces in the barrier 29.

In the embodiment shown in FIGS. 7a and 7b, an outer ring 291 of the barrier 29 is thinner than the remaining part of the barrier 29. When this barrier 29 bursts, it is highly likely that the bursting will not just result in a small hole somewhere in the barrier surface, but that most of or even the full venting aperture 27 is opened at once and the pressurised gas from inside the keg 10 will be able to escape the keg 10 unimpededly. Preferably, both the indented outer ring 291 and the thicker central circle 293 have a thickness inside the now claimed, optimal thickness range. Alternatively, the outer ring may be even thinner, for example in the range 0.02 mm to 0.5 mm, or alternatively in the range of 0.04 mm to 0.4 mm. Similarly, the central circle 293 may have a thickness that is more than 0.4 mm, possibly even a thickness equal to the wall thickness of the top portion 38b of the valve housing 38. As long as the outer ring 291 has a lower thickness, the barrier 29 will still burst when exceeding the predetermined burst pressure. With a barrier diameter of, for example, 10 mm, a width of the outer ring 291 may, for example, be somewhere between 1 and 3 mm, but outer rings 291 with smaller and larger widths are also foreseen.

In the embodiment shown in FIGS. 8a and 8b, a further indentation 292 in the form of a pair of intersecting grooves is added to the barrier surface. Such intersecting grooves may, for example, form a cross 292 or star. A length of one or both grooves may be in the range of 2 mm to 12 mm. Different grooves may have different lengths. The reduced barrier thickness at the cross 292 may be equal or similar to the barrier thickness in the outer ring 291. The optimal barrier thickness at the cross 92 depends on the desired bursting dynamics. Just like the outer ring 291, the added grooves may be provided at an inward and/or at an outward facing surface of the barrier 92.

It is noted that many alternative thickness profiles and patterns can be used in different applications. For example, the cross 292 of the embodiment of FIG. 8 can be used without the outer ring 291. Alternatively, small squares, circles, or other geometrical shapes may be used for the burst marks. Because of this even smaller thickness, an increasing pressure will cause the barrier 29 to break at the indentations 291, 292 first. A barrier 29 provided with indentations 291, 292 may or may not have a slightly thicker overall barrier thickness. For example, the overall barrier thickness is in the range of about 0.1 mm to about 0.5 mm and the wall thickness at the burst mark is in the range of about 0.02 mm to about 0.15 mm.

In the here shown exemplary embodiments, the indentations 291, 292 are provided at the barrier inner and outer surface. Alternatively, indentations may be provided at the barrier inner or outer surface only. Indentations 291, 292 at the inner and outer barrier surface may be identical, have different designs or have the same designs, but rotated over an angle between 0° and 90°. The design and exact thickness of the indentations influences the pressure at which the barrier 29 will burst and the shape of the valve opening that appears after the bursting. In comparison to the barrier 29 having a uniform thickness, as shown in FIG. 6a, the indentations 291, 292 provide better control of the exact pressure at which the barrier 29 will burst and better control over the bursting dynamics.

All barriers 29 described herein may be provided by injection moulding the barrier 29 as an integral part of the housing 38. During the injection moulding process, a shifting component may compress the area where the barrier 29 is formed to obtain a uniform thickness having predictable bursting dynamic properties. The resulting compressed area will have a smaller thickness than the surrounding parts of the injection moulded object, such that it is weak enough to burst at a desired pressure limit, but still strong enough to reliably seal the venting aperture 27 under normal operation conditions.

The preferred thickness of the barrier 29 depends on the material use for the housing, the specific geometric design of the barrier 29 and its connection to the rest of the valve housing 38 and the target pressure at which the barrier should burst. For example, the barrier 29 may have a thickness in the range of about 0.02 mm to about 0.5 mm, preferably in the range of 0.04 to 0.4 mm. Some advantages of using an integral barrier instead of a welded, glued or otherwise attached one are that only one material is needed for both the valve housing 21 and the barrier and a costly welding step can be omitted. Examples for suitable materials for the valve housing 21 and the integrated barrier 29 are POM, PET and PP, but other types of plastics may also be used.

The barrier 29 is configured to rupture if the internal pressure within the closure 12 (and within a keg 10 to which the closure 12 is fitted) exceeds a predetermined maximum allowable pressure. The predetermined maximum allowable pressure is preferably between the maximum working pressure of the keg 10 (that is the highest pressure expected to be experienced during use of the keg 10) and the failure pressure of the keg 10 (that is the pressure at which the keg 10 is predicted to fail).

In a preferred embodiment, the predetermined maximum allowable pressure is approximately 6 bar (gauge pressure, as used throughout the specification), and is between a maximum working pressure of approximately 5.5 bar and a keg failure pressure of approximately 7 bar. In this way the venting aperture 27 and barrier 29 allow the interior of a keg 10 to which the closure 12 is fitted to be automatically and completely vented if the internal pressure within the keg 10 exceeds a predetermined maximum pressure permitted by the closure 12.

It has been found that the above-described venting system allows reliable automatic venting of the closure 12 (and a keg 10 to which the closure 12 is attached) at a predetermined maximum allowable pressure with an acceptably small burst pressure variation between closures 12 of the same design. The above-described venting system is also simple and cost-effective due to the low cost of the barrier 29 and the lack of additional components required for securing an add-on barrier 29 to the valve housing.

A particular advantage of the integrally formed barrier 29 is that with a simple adjustment of the manufacturing process, a barrier 29 suitable for different applications can be obtained. The maximum pressure permitted by the closure 12 (that is the internal pressure at which automatic venting occurs) is governed by the strength of the barrier 29. The barrier strength is affected by many aspects such as, for example, the materials selected for the valve housing 38, the thickness or thickness profile of the barrier 29, the presence or absence of any indentation, burst marks or pre-weakened areas and the shape and dimension of the barrier 29. The maximum pressure permitted by the closure 12 may therefore be varied by controlling one or more of these aspects. It is possible, therefore, to form different barriers 29 just by, for example, adjusting or replacing a moulding component that is used for compressing the area where the barrier 29 is formed during the fabrication process. This results in the useful advantage of being able to form different closures 10 that provide different maximum permitted pressures for different applications.

Many modifications may be made to the above examples without departing from the scope of the present invention as defined in the accompanying claims. For example, in the above-described embodiment, the closure 12 is configured to be snap fitted to the neck 16 of a keg 10 including an annular ring around the neck 16. However, other attachment mechanisms are also possible. For example, the closure 12 could be configured to be screw fitted to a neck 16 with external threading, in which case the annular wall 32 of the attachment part 20 could be provided with internal screw threading.

In addition, the above-described embodiments relate to a Type-A closure 12 for use in combination with standard Type-A filling heads and dispense heads. However, in other embodiments the closure could equally be configured for use with other types of filling and dispensing apparatus. For example, a closure employing one or more of the above-described housing construction (with an integrated outer housing wall and inner duct), venting system could equally include a head portion and valve arrangement configured to cooperate with Type-G, Type-D or Type-S filling heads and dispense heads.

In the above-described embodiment the valve housing of the closure is provided by an annular wall that defines a main body of the housing and a head portion that defines a top portion of the housing, the annular wall and the head portion being formed separately to each other and configured for mutual attachment. However, in other embodiments at least a portion of the wall forming the main body of the valve housing could equally be integrated together with the head portion. For example, the closure could comprise an attachment part including a head portion for attachment to a filling head or dispense head, and first and second concentric annular walls extending downwardly from the head portion, with the outer one of the annular walls being configured for connection to the neck of a keg, and the inner one of the annular walls being configured to be received within the neck of the keg and to provide a housing for the valve arrangement.

In the above-described embodiment, the outer housing wall (forming the main body of the valve housing) and the inner duct (providing an inner flow path through the closure and an attachment point for an elongate tube or spear) are separate elements. However, in other embodiments the outer housing wall and the inner duct could equally be formed as a single integrated component.

While the present invention has been illustrated by the description of various embodiments thereof, and while the embodiments have been described in considerable detail, it is not intended to restrict or in any way limit the scope of the appended claims to such detail. The various features discussed herein may be used alone or in any combination. Additional advantages and modifications will readily appear to those skilled in the art. The invention in its broader aspects is therefore not limited to the specific details and illustrative examples shown and described. Accordingly, departures may be made from such details without departing from the scope of the general inventive concept.

1-20. (canceled)

21. A closure for a beverage keg for the pressurised delivery of a beverage, the closure comprising:
a valve housing comprising a valve housing wall and an inlet and configured to house a valve for controlling a flow of pressurised gas through the inlet into a headspace of the beverage keg;
a venting aperture in the valve housing wall, separate from the inlet and arranged to vent the headspace of the beverage keg; and
a barrier, integrally formed with the valve housing wall and arranged to seal the venting aperture such that the closure is able to retain the pressurised gas within the keg when the closure is arranged in an unvented configuration, the barrier being configured to rupture due to internal pressure from within the keg in order to switch the closure into a vented configuration in which the venting aperture is no longer sealed by the barrier,
wherein the barrier is formed as a geometrical shape having a barrier diameter or a barrier width in the range of 7 mm to 12 mm and wherein, in at least a part of the barrier, a barrier thickness is lower than a thickness of the valve housing in the immediate surroundings of the venting aperture and in the range of 0.02 mm to 0.5 mm.

22. A closure according to claim 21, wherein, in at least a part of the barrier, the barrier thickness is in the range of 0.04 mm to 0.4 mm.

23. A closure according to claim 21, wherein the barrier width or the barrier diameter is in the range of 9.5 mm to 12 mm.

24. A closure according to claim 21, wherein the barrier thickness is substantially uniform.

25. A closure according to claim 21, wherein the barrier thickness is not uniform.

26. A closure according to claim 25, wherein the barrier thickness is in the range of 0.02 mm to 0.5 mm, preferably in the range of 0.04 mm to 0.4 mm, in a region at a circumference of the geometrical shape.

27. A closure according claim 25, wherein the barrier comprises an indented region with a reduced barrier thickness relative to its immediate surroundings.

28. A closure according to claim 27, wherein the indented region comprises a pair of intersecting grooves.

29. A closure according to claim 28, wherein a length of at least one of the intersecting grooves is in the range of 2 mm to 12 mm, preferably in the range of 6 to 10 mm.

30. A closure according to claim 27, wherein the reduced barrier thickness at the indented region is in the range of 0.05 mm to 0.4 mm.

31. A closure according to claim 27, wherein the indented region is provided at an inward and/or at an outward facing surface of the barrier.

32. A closure according to claim 21, wherein the barrier is arranged at an inward or at an outward facing opening of the venting aperture.

33. A closure according to claim 21, wherein the closure is formed of at least one of TPU, HDPE and POM.

34. A closure for a beverage keg for the pressurised delivery of a beverage, the closure comprising:
a valve housing comprising an inlet and configured to house a valve for controlling a flow of pressurised gas through the inlet into a headspace of the beverage keg, the valve housing comprising:
a head portion for receiving at least an upper portion of the neck of the beverage keg and for attachment to a beverage filling and/or dispense system,
a body portion configured to be at least partially inserted into a neck of the beverage keg;
a venting aperture in a wall of the head portion, separate from the inlet and arranged to vent the headspace of the beverage keg; and
a barrier, integrally formed with the wall of the head portion and arranged to seal the venting aperture such that the closure is able to retain the pressurised gas within the keg when the closure is arranged in an unvented configuration, the barrier being configured to rupture due to internal pressure from within the keg in order to switch the closure into a vented configuration in which the venting aperture is no longer sealed by the barrier;
wherein the head portion, the body portion and the barrier are integrally formed together such that the valve housing defines a single component of the closure.

35. A closure according to claim 34, wherein the barrier is formed as a geometrical shape having a barrier diameter or a barrier width in the range of 7 mm to 11 mm and wherein, in at least a part of the barrier, a barrier thickness is lower than a thickness of the valve housing in the immediate surroundings of the venting aperture and in the range of 0.1 mm to 0.5 mm.

36. A closure according to claim 34, wherein the closure is obtained by injection moulding and wherein the barrier is obtained by temporarily compressing a barrier portion of the valve housing during the injection moulding.

37. A beverage keg supplied with or fitted with a closure according to claim 34.

38. A method of forming a closure according to claim 27, the method comprising:
injection moulding a valve housing of the closure;
compressing a barrier portion of the valve housing during the injection moulding; and
forming an indented region of the barrier portion, the indented region having a reduced barrier thickness relative to its immediate surroundings.

39. A method according to claim 38, wherein forming the indented region comprises scoring a region of the barrier portion with a laser to obtain a pair of intersecting grooves in the barrier portion.

40. A method according to claim 39, wherein scoring the region of the barrier portion comprises forming at least one of the intersecting grooves with a length in the range of 2 mm to 12 mm, preferably in the range of 6 to 10 mm.
